(19) United States
(12) Patent Application Publication
(10) Pub. No.: US 2002/0125788 A1
(43) Pub. Date: Sep. 12, 2002

(54) AXIAL COOLING TUBES PROVIDED WITH CLAMPING MEANS

(76) Inventors: MATS LEIJON, VASTERAS (SE); BERTIL LARSSON, VASTERAS (SE); GUNNAR KYLANDER, VASTERAS (SE); SOREN BERGGREN, VASTERAS (SE); BENGT ROTHMAN, VASTERAS (SE); IVAN JONAS, VASTERAS (SE); ARNE EDMAN, VASTERAS (SE); JONNY HYLANDER, BJORKETORP (SE)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 09/194,560

(22) PCT Filed: May 27, 1997
(86) PCT No.: PCT/SE97/00895

(30) Foreign Application Priority Data
May 29, 1996 (SE) 9602079-7
May 29, 1996 (SE) 9602089-6
Feb. 3, 1997 (SE) 9700351-1

(51) Int. Cl. H02K 1/06

(52) U.S. Cl. 310/259; 310/217

(57) ABSTRACT

A rotating electric machine, comprising a stator (1) wound with high voltage cable and provided with stator teeth (4) extending radially inwards from an outer yoke portion (23), wherein at least one stator tooth (4) in a tooth sector (18) is provided with at least one axially running cooling duct (24) connected to a cooling circuit (25) in which coolant is arranged to circulate and in that the axially running cooling tube (24) is connected at least at one end of the stator (1) to a clamping means (27, 28) for axial compression of the stator (1).

### TECHNICAL FIELD

The present invention relates to rotating electric machines such as synchronous machines. Such machines can be used as generators for connection to the distribution or transmission power network, hereafter called power network. The invention also comprises double-fed machines, applications in asynchronous static current converter cascades, outer pole machines and synchronous flux machines, as well as alternating current machines. The invention relates particularly to a clamping means and with the clamping means combined cooling system of such machines.

### BACKGROUND ART

High-voltage rotating electric machines can be designed for voltages up to 36 kV. This has normally been considered to be an upper limit. In the case of generators, this means that a generator must be connected to the power network via a transformer which steps up the voltage to the level of the power network. The voltage of a power network can be in the range of 130-400 kV, but even power networks up to 800 kV exist.

In order to explain and describe the invention a short explanation of a rotating electric machine exemplified by a synchronous machine will be given. The explanation concern basically the magnetic circuit in such a machine and how it is classically built. Since the magnetic circuit as referred to in most cases is in the stator the magnetic circuit here referred to is called a stator comprising laminated sheets which winding is called stator winding and that the slots for the winding in the laminated sheets is called stator slots or simply slots.

Most synchronous machines have a field winding in the rotor, where the main flux is generated by direct current, and an alternating current winding in the stator.

The stator frame in large sized synchronous machines is often a welded construction. The laminated core is usually built from varnished 0.35 or 0.5 mm electrical steel. The sheets are manufactured in segmented form or ring form depending on the size of the machine. The sheets are in larger machines punched in segments which are attached to the stator frame with wedges/dovetails. The laminated core is kept together with pressure fingers and pressure rings.

For cooling the windings of the synchronous machine there exist three different types of cooling systems. In air-cooling, the winding of the stator as well as the winding of the rotor is cooled by air flowing through the windings. Air-cooling ducts are arranged in the laminated sheets of the stator as well as in the rotor. In radial ventilation and cooling by air the laminated core is, at least for medium sized and large sized machines divided in packets comprising radial and axial ventilation ducts disposed in the core. The cooling air can be ambient air but at powers above 1 MW mainly a closed cooling system with a heat exchanger is used. Hydrogen cooling is normally used in large turbo-generators and in large synchronous compensators. The cooling method works in the same way as in air-cooling with a heat exchanger, but instead of air as cooling medium hydrogen is used. Hydrogen has better cooling capabilities than air, but difficulties arise at sealings and to detect leakage. In turbo-generators of power range 500-1000 MW it is also known to use water cooling of the winding of the stator as well as of the winding of the rotor. The cooling ducts are made as tubes placed inside conductors in the winding of the stator. A problem in large machines is that the cooling tends to become non-uniform and that temperature variations arise in the machine.

The stator winding is located in slots in the sheet iron core, the slots normally having a rectangular or trapezoidal cross section. Each winding phase comprises a number of coil groups connected in series and each coil group comprises a number of coils connected in series. The different parts of the coil are designated coil side for the part which is placed in the stator and end winding for that part which is located outside the stator. A coil comprises one or more conductors brought together in height and/or width.

Between each conductor there is a thin insulation, for example epoxy/glass fibre.

The coil is insulated from the slot with a coil insulation, that is, an insulation intended to withstand the rated voltage of the machine to earth. As insulating material, various plastic, varnish and glass fibre materials may be used. Usually, so-called mica tape is used, which is a mixture of mica and heard plastic, especially produced to provide resistance to partial discharges, which can rapidly break down the insulation. The insulation is applied to the coil by winding the mica tape around the coil in several layers. The insulation is impregnated, and then the coil side is painted with a graphite-based paint to improve the contact with the surrounding stator which is connected to earth potential The cross-sectional area of the windings is determined by actual current density and by the method of cooling. Conductor and coil is usually arranged with a rectangular shape in order to maximize the amount of conductor material in the track. A typical coil is formed by so called Roebel-bars, where some of the conductors can be made hollow for cooling medium. A Roebel-bar contains several rectangular, copper conductors connected in parallel, which are transposed 360 degrees along the slot. Known are also annular bars with 540 degrees transpositions. The transpositions are performed in order to avoid the development of circulating currents in the cross-section of the conductor material as seen from the magnetic field.

Due to mechanical and electrical reasons there are certain upper limits which a machine cannot exceed. The power of the machine is determined mainly by three factors:

The cross-sectional area of the windings. At normal working temperature copper has a maximum value of 3-3.5 A/mm².

Maximum magnetic flux density in the material of the stator and the rotor.

Maximum electric-field strength in the insulating material, the so-called dielectric strength.

It is considered that coils for rotating generators can be manufactured with good results within a voltage range of 3-25 kV.

Attempts to develop the generator for higher voltages however, have been in progress for a long time. This is obvious, for instance from “Electrical World”, Oct. 15, 1932, pages 524-525. This describes how a generator designed by Parson 1929 was arranged for 33 kV. It also describes a generator in Langerbrugge, Belgium, which produced a voltage of 36 kV. Although the article also speculates on the possibility of increasing voltage levels still further, the development was curtailed by the concepts upon which these generators were based. This was primarily because of the shortcomings of the insulation system where varnish-impregnated layers of mica oil and paper were used in several separate layers.

In a report from the Electric Power Research Institute, EPRI, EL-3391 from April 1984, an account is given of generator concepts for achieving higher voltage in an electric generator with the object of being able to connect such a generator to a power network without intermediate transformers. Such a solution is assessed in the report to offer good gains in efficiency and considerable financial advantages. The main reason that it was deemed possible in 1984 to start developing generators for direct connection to power networks was that a superconducting rotor had been developed at that time. The considerable excitation capacity of the superconducting field winding enables the use of airgap-winding with sufficient thickness to withstand the electrical stresses.

By combining the concept deemed most promising according to the project, that of designing a magnetic circuit with winding, known as “monolithe cylinder armature”, a concept in which two cylinders of conductors are enclosed in three cylinders of insulation and the whole structure is attached to an iron core without teeth, it was assessed that a rotating electric machine for high voltage could be directly connected to a power network. The solution entailed the main insulation having to be made sufficiently thick to withstand network-to-network and network-to-earth potentials. Obvious drawbacks with the proposed solution, besides its demanding a superconducting rotor, are that it also requires extremely thick insulation, which increases the machine size. The end windings must be insulated and cooled with oil or freones in order to control the large electric fields at the ends. The whole machine must be hermetically sealed in order to prevent the liquid dielectric medium from absorbing moisture from the atmosphere.

Certain attempts at a new approach as regards the design of synchronous machines are described, inter alia, in an article entitled “Water-and-oil-cooled Turbogenerator TVM-300” in J. Elektrotechnika, No. 1, 1970, pp. 6-8, in U.S. Pat. No. 4,429,244; “Stator of Generator” and in Russian patent document CCCP Patent 955369.

The water- and oil-cooled synchronous machine described in J. Elektrotechnika is intended for voltages up to 20 kV. The article describes a new insulation system consisting of oil/paper insulation, which makes it possible to immerse the stator completely in oil. The oil can then be used as a coolant while at the same time using it as insulation. To prevent oil in the stator from leaking out towards the rotor, a dielectric oil-separating ring is provided at the internal surface of the core. The stator winding is made from conductors with an oval hollow shape provided with oil and paper insulation. The coil sides with their insulation are secured to the slots made with rectangular cross section by means of wedges. As coolant, oil is used both in the hollow conductors and in holes in the stator walls. Such cooling systems, however, entail a large number of connections of both oil and electricity at the coil ends. The thick insulation also entails an increased radius of curvature of the conductors, which in turn results in an increased size of the winding overhang.

The above-mentioned U.S. patent relates to the stator part of a synchronous machine which comprises a magnetic core of laminated sheet with trapezoidal slots for the stator winding. The slots are tapered since the need of insulation of the stator winding is less towards the interior of the rotor where that part of the winding which is located nearest the neutral point is disposed. In addition, the stator part comprises a dielectric oil-separating cylinder nearest the inner surface of the core which may increase the magnetization requirement relative to a machine without this ring. The stator winding is made of oil-immersed cables with the same diameter for each coil layer. The layers are separated from each other by means of spacers in the slots and secured by wedges. What is special regarding the winding is that it comprises two so-called half-windings connected in series. One of the two half-windings is located, centred, inside an insulation sleeve. The conductors of the stator winding are cooled by surrounding oil. The disadvantages with such a large quantity of oil in the system are the risk of leakage and the considerable amount of cleaning work which may result from a fault condition. Those parts of the insulation sleeve which are located outside the slots have a cylindrical part and a conical termination reinforced with current-carrying layers, the duty of which is to control the electric field strength in the region where the cable enters the end winding.

From CCCP 955369 it is clear, in another attempt to raise the rated voltage of the synchronous machine, that the oil-cooled stator winding comprises a conventional high-voltage cable with the same dimension for all the layers. The cable is placed in stator slots formed as circular, radially disposed openings corresponding to the cross-section area of the cable and the necessary space for fixing and for coolant. The different radially disposed layers of the winding are surrounded by and fixed in insulated tubes. Insulating spacers fix the tubes in the stator slot. Because of the oil cooling, an internal dielectric ring is also needed here for sealing the coolant against the internal air gap. The design shown has no tapering of the insulation or of the stator slots. The design exhibits a very narrow radial waist between the different stator slots, which means a large slot leakage flux which significantly influences the magnetization requirement of the machine.

In U.S. Pat. No. 4,208,597 an improved cooling is provided for the end region of a stator core of a large dynamoelectric machine showing an improved ventilation plate which can be used in direct contact with the finger plate at the end of the stator core to provide cooling and mechanical stability in the core end region. U.S. Pat. No. 4,745,314 shows a liquid-cooled motor which has cooled liquid ducts formed in the laminated core of the stator. This improves the leakproof performance of the coolant ducts of such a liquid-cooled motor. U.S. Pat. No. 5,365,132 shows an improved cooling arrangement for a dynamoelectric machine of the type having a plurality of stacked laminations forming a stator core. The arrangement is further showing a plurality of cooling air ducts formed in the lamination adjacent a radially outer termination of at least some of the winding slots. EP 0684682 shows a rotating electrical machine with openings in its stator teeth occupying a substantial part of the surface area of each tooth so that the stator windings have only a short thermal path to axial cooling ducts created by the openings.

### OBJECT OF THE INVENTION

The object of the present invention is to mechanically connect layers of the sheets of the stator so that the packets of layers defining the stator core will not be exposed to vibrations under working conditions. The connection will also be made so that the mechanical properties of the core is intact.

An other object of the invention is to combine the connection of the sheets into packet of layers with cooling of the core.

A condition for the invention is that the rotating electric machine should shows a complete new design. This new design involves construction of the rotating electric machine in a way so that its alternating current winding comprises at least one conductor, around which a solid isolation comprising a semiconducting layer near the conductor and an outer semiconducting layer around the insulator.

A rotating electric machine as presented shows many advantages and can be designed for direct connection to a power network without a transformer therebetween.

The connection of the laminated sheets is done by axial clamping means which are electrically insulated from the layers of laminated sheets. The insulation can be made by coating the clamping means with an outer insulating layer or by manufacturing the clamping means of insulation material. The clamping means are pulled through axial holes in the stator teeth and also through holes in the connecting part of the stator, the so-called stator yoke if necessary.

### SUMMARY OF THE INVENTION

The present invention relates to an arrangement for cooling and a clamping means combined with the cooling arrangement, which enable compression of the laminations in the stator stack with the aid of cooling tubes arranged axially in the stator.

The arrangement comprises axially-running tubes, electrically insulated, which are drawn through axial apertures through the stator teeth. The tubes are permanently glued in the apertures to ensure good cooling capacity when coolant is circulated in the tubes. The tubes run along the entire axial length of the stator teeth and are spliced in the stator ends.

According to a particularly preferred embodiment of the invention, at least one of the semiconducting layers, preferably both, have the same coefficient of thermal expansion as the solid insulation. The decisive benefit is thus achieved that defects, cracks or the like are avoided at thermal movement in the winding.

### BRIEF DESCRIPTION OF THE DRAWINGS

The invention will be described in more detail with reference to the accompanying drawings.

FIG. 1 shows schematically a perspective view of a section taken diametrically through the stator of a rotating electrical machine.

FIG. 2 shows a cross-sectional view of a high-voltage cable according to the present invention,

FIG. 3 shows schematically one sector of a rotating electric machine,

FIG. 4 shows a sector of a stator according to FIG. 3,

FIG. 5 shows section along the line A-A in FIG. 4 with a clamping means having axial cooling tubes in accordance with the present invention.

FIG. 6 shows one sector of the stator in a rotating electric machine with cooling tubes and bolts drawn in.

FIG. 7 shows a radial section B-B through FIG. 6 with a clamping device with bolts according to the present invention

FIG. 8 shows another radial section with axially running cooling-tube loops and a clamping device according to the invention.

### DESCRIPTION OF THE INVENTION

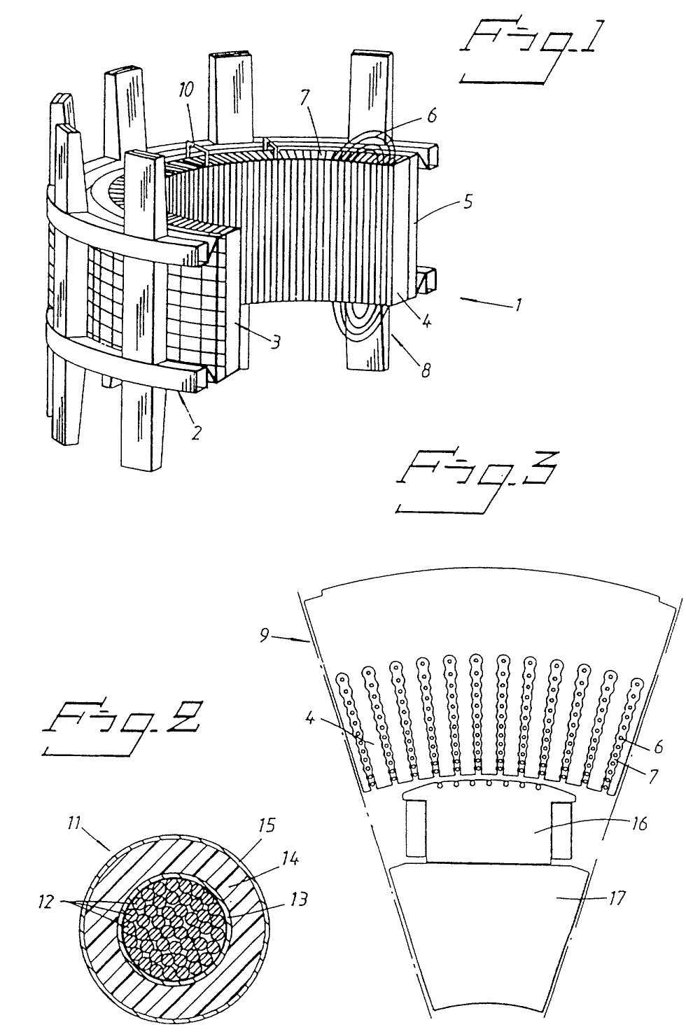

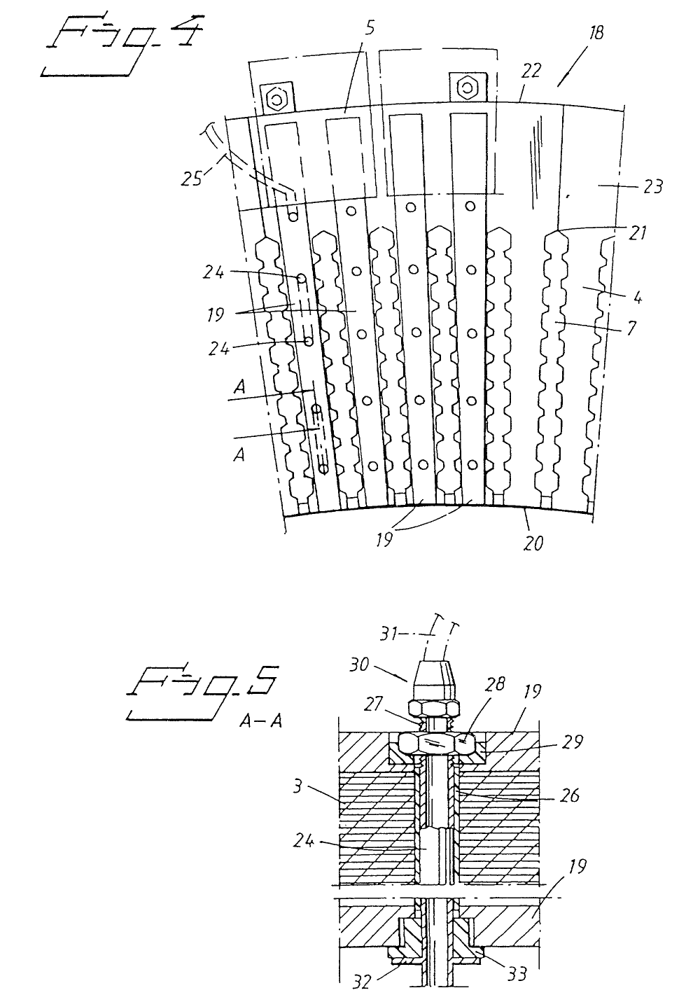

FIG. 1 shows a part of an electric machine in which the rotor has been removed to show more clearly the arrangement of a stator 1. The main parts of the stator 1 constitute a stator frame 2, a stator core 3 comprising stator teeth 4 and a stator yoke 5. The stator also comprises a stator winding 6 composed of high-voltage cable situated in a space 7 shaped like a bicycle chain, see FIG. 3, formed between each individual stator tooth 4. In FIG. 3 the stator winding 6 is only indicated by its electric conductors. As can be seen in FIG. 1, the stator winding 6 forms an end-winding package 8 on both sides of the stator 1. It is also clear from FIG. 3 that the high-voltage cable has several dimensions, arranged in groups depending on the radial position of the cables in the stator 1.

In large machines each stack of laminations is formed by fitting punched segments 9 of suitable size together to form a first layer, after which each subsequent layer is placed at right angles to produce a complete plate-shaped part of a stator core 3. The parts are held together by pressure legs 10 pressing against pressure rings, fingers or segments.

FIG. 2 shows a cross-sectional view of a high-voltage cable 11 according to the invention. The high-voltage cable 11 comprises a number of strands 12 of copper (Cu), for instance, having circular cross section. These strands 12 are arranged in the middle of the high-voltage cable 11. Around the strands 12 is a first semiconducting layer 13, and around the first semiconducting layer 13 is an insulating layer 14, e.g. crosslinked polyethylene (XLPE) insulation. Around the insulating layer 14 is a second semiconducting layer 15. Thus the concept “high-voltage cable” in the present application does not include the outer protective sheath that normally surrounds such cables for power distribution.

FIG. 3 shows schematically a radial sector of a machine with a segment 9 of the stator 1 and with a rotor pole 16 on the rotor 17 of the machine. It can also be seen that the stator winding 6 is arranged in the space 7 resembling a bicycle chain, formed between each stator tooth 4.

FIG. 4 shows an outermost tooth sector 18 comprising six stator teeth 4, four of which in the figure are provided with a pressure finger 19 extending from the stator yoke 5 in towards the tip 20 of the stator tooth.

The tooth height is defined as the radial distance from the tip 20 of a tooth to the outer end 21 of the space 7 resembling a bicycle chain. The length of a stator tooth is thus equivalent to the tooth height. Furthermore, the yoke height is defined as the radial distance from the outer end 21 of the space 7 resembling a bicycle chain, to the outer edge 22 of the stator core. This latter distance denotes the width of an outer yoke portion 23.

In a high-voltage rotating electric machine of the type described above at least one stator tooth 4 is provided according to the present invention, see FIG. 4, with at least one axially-running cooling tube 24 connected to a cooling circuit 25 in which coolant is arranged to circulate. To achieve efficient cooling, cooling tubes are preferably arranged in every stator tooth. According to the embodiment of the invention shown in FIG. 4 four cooling tubes are arranged to run axially through the actual tooth, whereas another two cooling tubes are arranged to run axially through the outer yoke portion 23 of the sector shown. All cooling tubes in the figure shown are also radial aligned.

Each cooling tube 24 is electrically insulated and provided with an insulating layer, not shown, in order to avoid contact with the metal in the stator tooth 4 or in the outer yoke portion 23. A thermally conducting glue may alternatively be used for attachment.

FIG. 5 shows a clamping means according to one embodiment of the invention in which the cooling tube 24 extends out through a stator 3 built up of segments 9. The tube is provided with an insulating layer 26, possibly combined with a filling to increase thermal conductivity. The cooling tube 24 is provided at its end with a tapped end portion 27 onto which a nut 28 can be screwed. The end portion 27 extends through the pressure finger 19. The end part is also provided with an insulating washer 29 to insulate it from the stator core 3 and the pressure finger 19. The end part is also provided with a tube connection 30 to connect the end portion with a connection cooling tube 31 connected to the cooling circuit 25, for instance.

By tightening the nut 28 against the insulating washer 29 and the pressure finger 19, an axial compressive force is achieved in the cooling tube 24 which is drawn towards a counter-support on the other side of the stator, or another clamping means of the same type. Alternatively clamping can be effected against a shoulder 32 secured to the cooling tube 24. Pressure fingers 19 are also provided at this second side. Here, too, pressure fingers and cooling tubes are of course insulated here, too, from the stator core by suitably shaped washers 33, etc.

Thus by using an axial cooling tube as a pulling tube, further clamping means for axially compressing the stator core can be eliminated.

The invention is not limited to the embodiments shown but is defined by the appended claims. Thus types of clamping means other than screw joints may be used, such as wedge or spring means, etc.

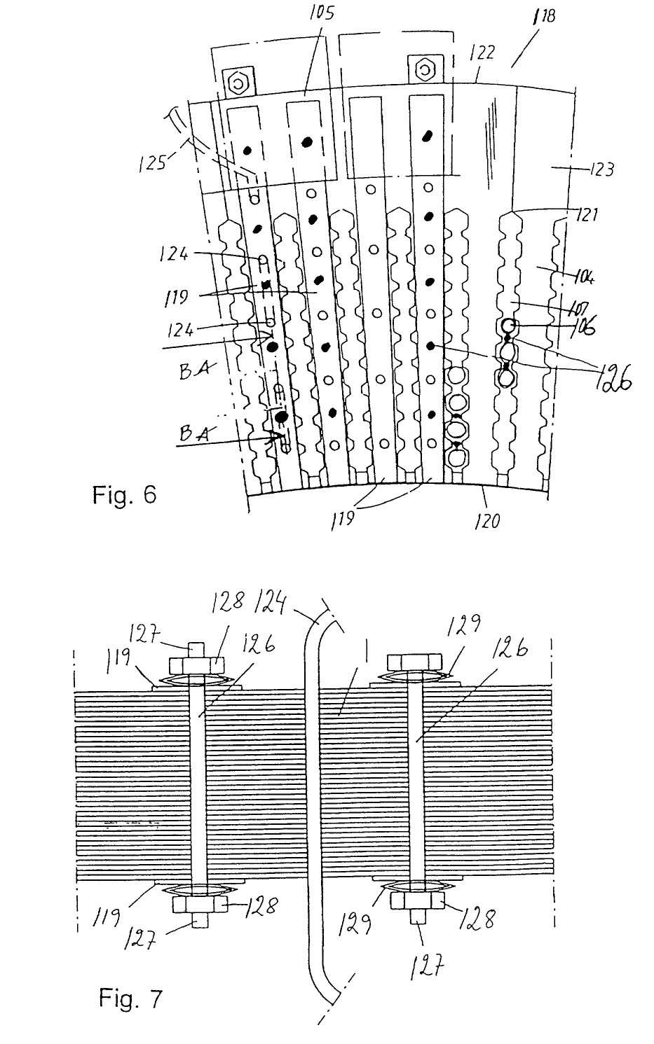

FIG. 6 shows like in FIG. 4 an outermost tooth sector 118 comprising six stator teeth 104, four of which in the figure are provided with a pressure finger 119 extending from the stator yoke 105 in towards the tip 120 of the stator tooth.

The tooth height is defined as the radial distance from the tip 120 of a tooth to the outer end 121 of the space 107 resembling a bicycle chain. The length of a stator tooth is thus equivalent to the tooth height. Furthermore, the yoke height is defined as the radial distance from the outer end 121 of the space 107 resembling a bicycle chain, to the outer edge 122 of the stator core. This latter distance denotes the width of an outer yoke portion 123.

In a high-voltage rotating electric machine of the type described above at least one stator tooth 104 is provided according to the present invention, see FIG. 6, with at least one axially-running cooling tube 124 connected to a cooling circuit 125 in which coolant is arranged to circulate. To achieve efficient cooling, cooling tubes are preferably arranged in every stator tooth. According to the embodiment of the invention shown in FIG. 6 four cooling tubes are arranged to run axially through the actual tooth, whereas one more cooling tube is arranged to run axially through the outer yoke portion 123 of the sector shown. All cooling tubes in the figure shown are also radially aligned. Each cooling tube 124 is electrically insulated and provided with an insulating layer, not shown, in order to avoid contact with the metal in the stator tooth 104 or in the outer yoke portion 123. A thermally conducting glue may alternatively be used for attachment.

The Figure also shows how a clamping device is placed between the cooling tubes as a first possible embodiment, and between the windings as a second possible embodiment. FIG. 7 shows a clamping device according to one embodiment of the invention in which one or more axial clamping devices are placed between each cooling tube 124 according to one embodiment of the invention, see also FIG. 6, in the magnetic material in the form of either insulated metal bolts or glass fibre bolts which are insulating per se. The clamping device 126 is provided at both ends with an end portion 127, preferably threaded, onto which a nut 128 can be screwed. The end portion 127 extends through the pressure finger 119. The end part is also provided with spring means 129, shown in the Figure as a plate spring, to take up axial fluctuations in the stator 1 caused by temperature. Some form of spring means is required to take up longitudinal expansion caused by heat transfer, which the pre-stressing is unable to deal with. The stator shall be permanently axially pre-stressed.

By tightening the end part with a nut 128, for instance, towards the spring means 129 and the pressure finger 119, an axial compressive force is achieved in the clamping device 126 which is drawn towards a counter-support or a similar tension device on the other side of the stator. Here, too, pressure fingers and cooling tubes are of course insulated from the stator core by suitably shaped washers, etc., not shown. In another advantageous embodiment, the clamping device 126 is disposed in the space 107 (slot) shaped like a bicycle chain, see FIG. 7, in the space between the stator windings 106, i.e. outside the magnetic material.

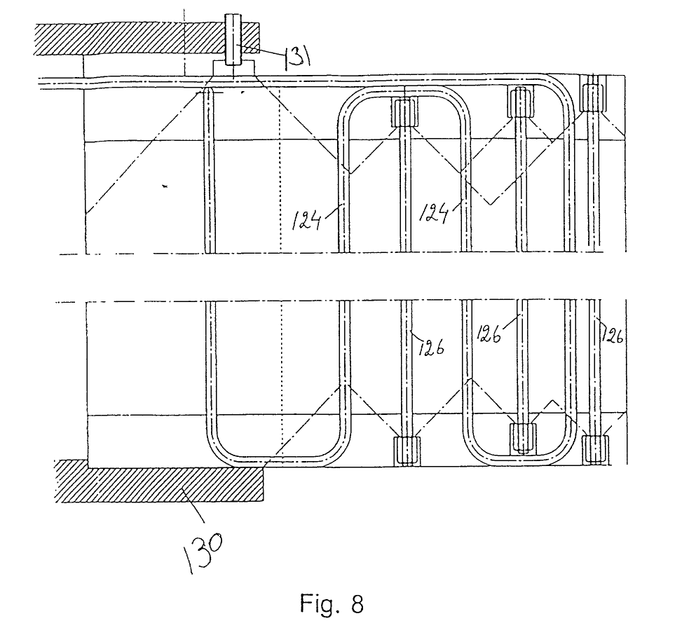

FIG. 8 shows a clamping device 126 in a radial section through a stator tooth, together with the cooling tubes 124 running axially to and fro. Together with the clamping device, a clamping yoke 130 provided with axially operating pressure fingers 131 effects an axial force compressing the stack of laminations.

The invention is not limited to the embodiments shown but is defined by the appended claims. Cooling tubes and clamping devices need not be radially aligned, for instance but their placing in tangential direction may vary instead.

1. A high-voltage rotating electric machine, comprising a magnetic core built by laminated steel and a winding placed in slots in the core of laminated steel, characterized in that the winding comprises an insulation system including at least two semiconducting layers, each layer constituting essentially an equipotential surface and also including solid isolation disposed therebetween and that a clamping device is extending axially from the laminated steel and arranged for holding a packet of sheets together and whereby at least one end of the core of the laminated steel is connected to at least one clamping device for axially pressing a packet of sheets together at a predetermined amount of tension.

2. A machine as claimed in claim 1, characterized in that the clamping device is extending axially through the magnetic core.

3. A machine as claimed in any of claim 1-2, characterized in that the axially extending clamping device is arranged with an inner space for circulating coolant.

4. A rotating electric machine, comprising a stator (1) wound with high-voltage cable and provided with stator teeth (4) extending radially inwards from an outer yoke portion (23), characterized in that at least one stator tooth (4) in a tooth sector (18) is provided with at least one axially-running cooling duct (24) connected to a cooling circuit (25) in which coolant is arranged to circulate and in that the axially-running cooling tube (24) is connected at least at one end of the stator (1) to a clamping means (27, 28) for axial compression of the stator (1).

5. A machine as claimed in claim 4, characterized in that the clamping means (27, 28) comprises at least one screw joint arranged, with the cooling tube (24), to axially clamp the laminations together.

6. A machine as claimed in either of claims 4 or 5, characterized in that at one side of the stator (1) the cooling tube (24) is provided with a firmly secured shoulder (32) and at the other side of the stator it is provided with a clamping means (27, 28) to axially clamp the stator laminations together.

7. A machine as claimed in claim 6, characterized in that the clamping means (27, 28) also acts against a pressure finger (19) for axial clamping of the stator laminations.

8. A machine as claimed in claim 7, characterized in that the clamping means (27, 28) is electrically insulated from the stator core (3).

9. A machine as claimed in claim 8, characterized in that the cooling tubes (24) are glued to the stator core (3).

10. A rotating electric machine comprising a wound stator (1) consisting of stator laminations and provided with stator teeth (104) extending radially inwards from an outer yoke portion (123), characterized in that the windings comprise a first semiconducting layer (13) around which layer an insulating layer (14) is arranged and a second semiconducting layer (15) arranged around the insulating layer (14), and that an axially running clamping device electrically insulated from the stator laminations is connected at least at one end of the stator (1) to at least one clamping device (126) for axial compression to predetermined pre-stressing of the stator (1).

11. A machine as claimed in claim 10, characterized in that the stator winding consists of high-voltage cable (11).

12. A machine as claimed in either of claims 10 or 11, characterized in that the clamping device (126) runs axially through the magnetic material of the stator (1).

13. A machine as claimed in either of claims 10 or 11, characterized in that the clamping device (126) runs between the high-voltage cables (11) in the space (107) formed between two adjacent stator teeth (104).

14. A machine as claimed in any of claims 10-13, characterized in that the entire clamping device (126) is made of an insulating material, preferably glass fibre.

15. A machine as claimed in any of claims 10-13, characterized in that the clamping device (126) is arranged as a metallic pipe electrically insulated from the laminations of the stator (1).

16. A machine as claimed in either of claims 14 or 15, characterized in that the clamping device (126) is arranged to pre-stress the stator (1) with at least one spring device (129).

17. A machine as claimed in either of claims 14 or 15, characterized in that the clamping device (126) is arranged to pre-stress the laminated stack against the action of a rubber spring.

18. A machine as claimed in any of claims 10-17, characterized in that several clamping devices (126) are arranged in at least one stator tooth (104) so that each cooling tube (124) is flanked by an axially extending clamping device (126).

19. A machine as claimed in any of claims 10-18, characterized in that an additional clamping device (126) also runs through the yoke portion (123).

20. A machine as claimed in any of claims 10-19, characterized in that clamping devices (126) and cooling tubes (124) are arranged radially aligned.

21. A machine as claimed in any of claims 1-3, characterized in that at least one of the layers has substantially the same coefficient of thermal expansion as the solid insulation.

22. A machine as claimed in any of the preceding claims, characterized in that said winding is formed of a cable comprising one or more current-carrying conductors, each conductor having a number of strands, an inner semiconducting layer provided around each conductor, an insulating layer of solid insulating material provided around said inner semiconducting layer, and an outer semiconducting layer provided around said insulating layer.
